(19) United States
(12) Patent Application Publication
(10) Pub. No.: US 2026/0166669 A1
(43) Pub. Date: Jun. 18, 2026

(54) METHOD FOR MONITORING A MACHINING PROCESS IN A MACHINE TOOL

(71) Applicant: REISHAUER AG, Wallisellen (CH)

(72) Inventor: Christian DIETZ, Wallisellen (CH)

(73) Assignee: REISHAUER AG, Wallisellen (CH)

(21) Appl. No.: 19/109,750

(22) PCT Filed: Sep. 1, 2023
(86) PCT No.: PCT/EP2023/073991

§ 371 Date: Mar. 7, 2025

(30) Foreign Application Priority Data
Sep. 9, 2022 (CH) 001056/2022

(51) Int. Cl. B23Q 17/22

(52) U.S. Cl. CPC B23Q 17/22

(57) ABSTRACT

In a method for monitoring a machining process in a machine tool, values of a measured variable are received, said values having been determined during a machining stroke in the machining of a workpiece. At least one test value based on the values of the measured variable is compared with a tolerance limit (Ui, Li). The tolerance limit is automatically determined by performing a statistical analysis of a plurality of reference values (Rj) determined by measurements taken during the machining of a plurality of previous workpieces, each reference value being based on one or more values of the measured variable obtained during the machining of one of the previous workpieces.

### TECHNICAL FIELD

The present invention relates to a method for monitoring a machining process in a machine tool. The machine tool may be a gear cutting machine for machining toothed workpieces, in particular a gear grinding machine.

### PRIOR ART

During the machining of workpieces in a machine tool, production deviations naturally occur, which manifest themselves in deviations of the actually manufactured true geometry of the workpieces from a specified target geometry. The manufacturing deviations can be caused by deviations of the actual machining process from the intended process. Process deviations can be caused, among other things, by operator errors, malfunctions or wear of the various components of the machine tool.

For time and cost reasons, the machined workpieces can usually only be randomly inspected for machining errors. If the machining process is, for example, a generating grinding process with which gear teeth are fine-machined, the gear inspection of an individual workpiece typically takes significantly longer than the actual machining. Individual inspection of all workpieces would therefore not be economical. Machining defects are therefore often only detected after the workpiece has been installed in a gear, during a so-called end-of-line (EOL) inspection. At this stage, a defective workpiece entails high costs.

It is therefore desirable to detect process deviations if possible already during machining (“online”) or at least immediately afterwards (“inline”) in order to be able to discard defectively manufactured workpieces in good time and to be able to intervene in the process in a corrective manner. For this purpose, it is known to continuously determine measured values on the machine tool and to compare these measured values with tolerance limits. The measured values can be, for example, the power consumption of a tool or workpiece spindle or a signal from a vibration sensor. If the tolerance range limited by the tolerance limits is exceeded, this indicates a process deviation. In this case, the workpiece currently being processed can be discarded as defective and, if necessary, one can intervene in the process in a regulating manner.

Setting tolerance limits is a very demanding task that requires a lot of expert knowledge. Furthermore, the definition of tolerance limits is an iterative process that is prone to errors.

In WO2022100972A2 it is proposed to measure two machine parameters during grinding of a gear by means of a grinding tool. If at least one of the machine parameters exceeds or falls below a specified value, taking into account a tolerance band, a signal is output. At least one of the machine parameters contains periodic signal components. These signal components are decomposed into the individual frequency components by a frequency analysis, and the frequency components are used for comparison with regard to their frequency and/or amplitude. Individual limit values can be defined for each frequency component.

Setting individual tolerance limits for the individual frequency components requires a particularly large amount of expert knowledge. For example, the operator who sets the tolerance limits must be able to judge the significance of the individual frequency components for possible machining errors. Often, the operator of a machine tool lacks this expert knowledge. Due to the large number of frequency components, setting such limits is also extremely time-consuming. The unavoidable process scatter further complicates this task. A complete picture of the scatter of all frequency components often only emerges after the production of several thousand workpieces. In practice, therefore, limit values are often set incorrectly. For example, limit values are set too wide, so that inadmissible process deviations are not even detected, or they are set too narrow, so that workpieces are discarded as defective, although they actually meet the requirements of manufacturing accuracy.

WO2021048027A1 discloses a method for monitoring a machining process in which a plurality of measured values is acquired while a tool is in machining engagement with a workpiece, including values of a power indicator indicating an instantaneous power consumption of the tool spindle during machining. A normalization operation is applied to at least a portion of these measured values, or to values of a quantity derived from the measured values, to obtain normalized values. The normalization operation depends on at least one of the following parameters: geometric parameters of the tool, geometric parameters of the workpiece and setting parameters of the machine tool. This makes it possible to compare measured values obtained with different process parameters. Also in this document, it is proposed to subject the measured values to frequency analysis. The document does not deal with the setting of tolerance limits.

WO 2020/193228 A1 discloses a method for automatic process monitoring during continuous generating grinding of pre-toothed workpieces, which enables early detection of grinding wheel breakout. During the machining of workpieces, at least one measurand is monitored. From this, a warning indicator for a grinding wheel breakout is determined. If the warning indicator points to a grinding wheel breakout, the grinding wheel is automatically inspected for a grinding wheel breakout. This document also does not deal with the setting of tolerance limits.

Against the background of constantly increasing demands on machining quality and a correspondingly decreasing error tolerance, methods are desired that unerringly detect even the smallest deviations or irregularities in the machining process. In generating grinding, for example, it is desirable not only to detect entire grinding wheel breakouts, but also to obtain indications of microcracks in the grinding wheel. Therefore, methods for automatic process monitoring are needed that can detect process deviations in a more objective and reliable manner than previous methods.

### SUMMARY OF THE INVENTION

In a first aspect, it is an object of the present invention to provide a method for monitoring a machining process in a machine tool that allows objective and reliable detection of process deviations without requiring special expert knowledge for setting tolerance limits.

This object is solved by a method according to claim 1. Further embodiments are provided in the dependent claims.

Thus, a method is proposed for monitoring a machining process in a machine tool in which a workpiece is machined with a tool in one or more machining strokes, comprising the following steps:
receiving values of a measurand (measured values) which have been determined by measurements on the machine tool during the machining stroke; and
comparing at least one test value with a tolerance limit, the at least one test value being based on the values of the measurand.

According to the invention, the tolerance limit is determined by performing a statistical analysis of a plurality of reference values which have been determined by measurements taken during the machining of a plurality of previous workpieces, wherein each reference value is based on one or more values of the measurand determined during the machining of one of the previous workpieces, and wherein for the statistical analysis of the reference values a measure of dispersion for the reference values is determined and the tolerance limit is set based on the measure of dispersion.

In the proposed method, a large number of reference values is available which were obtained during previous machining processes by measurements on other workpieces, preferably on the same machine. The reference values can be stored in a database and can be read out from the database during the process. The term “reference values” is not intended to suggest that these values are particularly reliable. Rather, this term is used merely to distinguish logically the data obtained in earlier machining processes from the current values of the measurand obtained during the machining process to be monitored, or the test values obtained therefrom. In this respect, an essential idea of the present invention is to make values of the same measurand during earlier machining processes usable for the evaluation of the current machining process by calculating the tolerance limits for the current machining process on the basis of a statistical analysis of reference values based on these earlier values.

This is based on the assumption that in practice the vast majority of the previously measured values or the reference values obtained therefrom were determined in machining processes for which there were no inadmissible process deviations. Only a few machining processes will be “bad” processes in practice, since such “bad” processes are usually soon recognized on the basis of manufacturing deviations and measures for correction are taken.

In practice, for example, a certain portion of all workpieces is usually measured after the machining process (e.g. every hundredth workpiece), so that after a certain number of workpieces an inadmissible process deviation would become noticeable through a manufacturing deviation of the workpieces concerned. Furthermore, if the workpieces are, for example, toothed workpieces, the workpieces are usually installed in gears after the machining process, and at least some of the finished gears are tested in a so-called end-of-line (EOL) test rig. Here as well, workpieces with inadmissible manufacturing deviations would soon be detected, in particular by a disturbing noise development in the gear. Reference values obtained during the machining of workpieces with manufacturing deviations can subsequently be marked accordingly in the database and thus excluded from the determination of tolerance limits or even specifically taken into account in the determination of tolerance limits.

As a statistical average over many machining processes, the reference values therefore essentially represent a “good” machining process, i.e. a machining process without inadmissible process deviations, and the statistical distribution of the reference values represents the typical distribution to be expected in a “good” machining process. This knowledge is exploited to perform an automatic setting of the tolerance limits.

As a result, tolerance limits are automatically set based on objective criteria without the operator needing in-depth knowledge of the machining process.

The tolerance limits determined in this way can be used in the machining process in two ways.

On the one hand, the comparison of the test value with the tolerance limit can be used to directly control the machining process. In particular, the machining process can be interrupted or automatically modified if the comparison indicates an inadmissible process deviation.

On the other hand, the tolerance limits themselves also represent a valuable interpretation aid for the operator. The operator can use the tolerance limits to distinguish “good” from “bad” test values. He can therefore objectively form his own picture of the quality of a current machining process. Ideally, this enables the operator to draw direct conclusions about the cause of any manufacturing deviations detected.

The steps of receiving measured values and comparing the test values based thereon with the tolerance limit are preferably performed repetitively, i.e., these steps are preferably repeated continuously during a processing operation.

The reference values may be stored in a database. The method can then involve retrieving the reference values to be statistically analyzed from the database. The measured values of the current machining process may themselves be made usable again for subsequent machining processes. For this purpose, a new reference value may be calculated based on these measured values, and the database may be updated by storing the new reference value in the database. By continuously adding new reference values to the database, the process becomes self-learning, so to speak, and constantly improves itself through the ever-increasing number of reference values.

In particular, in the method according to the invention, each reference value may correspond to a test value that has been determined for a previous workpiece based on measured values that were measured during the machining of the previous workpiece, i.e., the reference values are formed directly by test values of previous workpieces. However, it is also conceivable that the reference values were derived in some other way from the measured values of earlier machining operations. In particular, the test values that are compared with the tolerance limits may be the actual measured values directly, and several measured values determined one after the other in time may be compared with one and the same tolerance limit. On the other hand, the reference values from which this tolerance limit is determined may be formed by an average value (or other location parameter), maximum value, minimum value or other value characterizing the previous machining operation. It is sufficient if these reference values are stored in the database. In this way, less memory is required in the database than if all previous measured values were stored in the database and recalled each time the tolerance limits are calculated.

Reference values for each combination of workpiece geometry and type of tool may be stored in separate parts of the database, i.e. the reference values in a particular part of the database are always specific to a particular workpiece geometry and a particular type of tool. For each of these parts of the database, additional information about the workpiece geometry and about the type of tool may then be stored in the database. If applicable, the reference values may also be specific to a particular tool geometry. In the case of dressable tools, the tool becomes smaller after each dressing operation. In this case, it is conceivable to store the reference values, which were obtained from machining operations that took place after a specific dressing operation, in a separate area of the database in each case. In this case, additional information about the tool dimensions resulting from this dressing operation may be stored in the database. The tolerance limits may then be redefined after each dressing operation, using only those reference values for calculating the tolerance limits that were determined using a tool with the same or similar tool dimensions after dressing. In this context, “similar” tool dimensions are understood to be dimensions that lie within a predetermined band around the current dimensions of the tool. However, it is also conceivable to take the decreasing tool dimensions into account by performing a normalization operation, as described below. A combination of both approaches is also possible.

As already mentioned, the workpiece may be, for example, a toothed workpiece, in particular a gear, specifically a spur gear, a bevel gear or any other rotationally symmetrical workpiece with a regular sequence of teeth and tooth spaces. The machining process may in particular be a grinding process, specifically a gear grinding process such as generating or profile grinding. However, the invention is not limited to the machining of toothed workpieces or to grinding processes. For example, in the context of gear machining, the invention may also be used in gear hobbing, gear skiving or gear honing. The machining process may also be a dressing process, in which the tool is a dressing tool (in particular a rotating dressing wheel or a rotating dressing gear) and in which the workpiece is a grinding tool (in particular a grinding worm or a profile grinding wheel).

The measurand may be time-variable, so that in the method according to the invention time-dependent values of the measurand are received for a plurality of points in time during a machining stroke. These time-dependent values may then be used in various ways.

In a first, particularly simple variant, a time-independent test value is calculated from the time-dependent values of the measurand, the time-independent test value representing the values of the measurand over the entire machining stroke. Each reference value is also time-independent and is based on time-dependent values of the measurand over a machining stroke during the machining of one of the previous workpieces. By the statistical analysis of the time-independent reference values, at least one time-independent tolerance limit is determined, and the time-independent test value is compared with the at least one time-independent tolerance limit.

In a second, more complex variant, a plurality of time intervals of the machining stroke is specified, whereby the time intervals may all have the same length or different lengths and do not necessarily have to be immediately adjacent to one another. For each of the time intervals, at least one associated test value is determined, which is based on the values of the measurand determined during machining in the respective time interval. The test value may be, for example, the value of the measurand in the middle of the time interval in question, a mean value (or other location parameter in the sense of descriptive statistics) of the measurand in the time interval in question, or any other value that characterizes the behavior of the measurand in the respective time interval. At least one tolerance limit is determined for each of the time intervals. This is done on the basis of reference values, each of which is specific to the respective time interval, i.e. each of the reference values is based on time-dependent values of the measurand during machining of one of the previous workpieces in the respective time interval. The at least one test value for each of the time intervals is then compared with the at least one tolerance limit for the respective time interval.

In a further variant, a frequency analysis of the time-dependent values of the measurand is performed to determine a plurality of frequency components of the measurand. A plurality of frequency intervals is specified, whereby the frequency intervals may all have the same size or different sizes and do not necessarily have to be directly adjacent to each other. For each of the frequency intervals, at least one associated test value is determined based on the frequency components in the respective frequency interval. The test value may be, for example, a selected frequency component in the respective frequency interval, the maximum or integral of the frequency components in the respective frequency interval, or any other value characterizing the frequency content of the measurand in the respective frequency interval. At least one tolerance limit is determined for each of the frequency intervals. This is done on the basis of reference values, each of which is specific to the respective frequency interval, i.e. each reference value is based on frequency components in the respective frequency interval which have been determined by a frequency analysis of time-dependent values of the measurand during machining of one of the previous workpieces. The at least one test value for each of the frequency intervals is then compared with the at least one tolerance limit for the respective frequency interval.

In some embodiments, the workpiece is machined successively in at least two machining strokes. It is then advantageous if the tolerance limit is specific to the respective machining stroke, i.e., if different tolerance limits are determined individually per machining stroke.

Preferably, the reference values are based on measured values determined during the machining of previous workpieces in the same machining stroke on the same machine tool. However, it is also conceivable to use reference values that were determined during the machining of earlier workpieces in other machining strokes and/or on other, similar machine tools.

The statistical analysis of the reference values may be performed in various ways. The measure of dispersion may be, for example, a standard deviation or the size of a value interval in which a predetermined proportion of all reference values lie (e.g., the interquartile range). In some embodiments, the tolerance limit may then be set relative to a location parameter of the reference values (e.g., relative to the arithmetic mean or median) as a multiple of the standard deviation or as a multiple of the size of said value interval. In other embodiments, a limit of said value interval may directly form the tolerance limit, e.g. the limit of that value interval in which the lower 99% or 99.9% of all values lie.

In order to reduce the sensitivity of the method to particularities of a specific statistical analysis method, it may be provided that the tolerance limit is determined by combining at least two statistical analysis methods. Alternatively or additionally, it may be provided that the at least one value of the measurand or the test value derived therefrom is compared with at least two tolerance limits that have been determined by different statistical analysis methods.

For example, the time-dependent measurand may be at least one of the following quantities or derived from at least one of the following quantities:
a power indicator which is a measure of an instantaneous power consumption of a tool spindle or workpiece spindle of the machine tool; or
a vibration indicator that has been determined with at least one vibration sensor and representing vibrations of the machine tool.

In order to reduce the dependence of the test value on process parameters such as tool diameter, workpiece diameter and module or infeed, it may be provided that a normalization operation is performed during the determination of the test value in order to normalize the test value. The normalization operation depends on at least one process parameter, wherein the process parameter is at least one geometrical parameter of the tool, at least one geometrical parameter of the workpiece and/or at least one setting parameter of the machine tool. In this case, the normalization operation is performed in such a way that the normalized test value depends less strongly on the at least one process parameter than without the normalization operation. Such a normalization operation is particularly valuable if the measurand is a measure of the power consumption of the tool spindle or workpiece spindle.

As soon as at least one of said process parameters changes, the normalization operation is preferably recalculated. The recalculation of the normalization operation may in particular comprise applying a model describing an expected dependence of the reference values on the process parameters, in particular a model of a process force or process power.

For further consideration of the normalization operation, reference is made to the publication document WO2021048027A1, the contents of which are incorporated by reference in their entirety into the present disclosure.

The method may comprise outputting user information to a user of the machine tool, wherein the user information is based on the comparison of the at least one test value with the tolerance limit. For example, the result of the comparison may be displayed visually, e.g., on a display of a machine controller of the machine tool or on a display of a mobile terminal, for example, a laptop or tablet computer, wherein the mobile terminal need not necessarily be located at the same location as the machine tool, and/or an acoustic output may be provided. A visual output may be graphical, for example. Of course, there are countless other ways to output user information.

Alternatively or additionally, the method may comprise that the machining process is influenced depending on a result of the comparison of the test value with the tolerance limit. In particular, it may be provided that the machining process is stopped if the comparison shows that there is an inadmissible process deviation, or that a workpiece, during the machining of which an inadmissible process deviation was detected, is automatically discarded.

Based on the comparison of the at least one test value with the tolerance limit, a numerical process deviation indicator may be determined. In the simplest case, the process deviation indicator is a Boolean variable that indicates by one of its two possible values that an inadmissible process deviation exists (e.g. TRUE=inadmissible process deviation, FALSE=no inadmissible process deviation). The process deviation indicator may also be a more complex indicator, such as an array of Boolean, integer, or real-valued variables, each of which indicating the degree of deviation of a test variable from the assigned tolerance limit. The process deviation indicator or user information based on it may be output.

The method may also provide for the machine status to be checked automatically. This may be done ad hoc when an inadmissible process deviation is detected, or the machine condition may be checked independently of the actual monitoring of the machining process at regular intervals, e.g. during machining pauses. For checking the machine condition, the method may comprise:
performing a machine test cycle in which at least a portion of the machine axes are selectively actuated and condition data associated with that actuation is determined by measurements; and
performing condition diagnostics in which the condition data is compared with at least one reference condition variable to determine at least one machine condition indicator,
wherein the process deviation indicator and the machine condition indicator are used to determine a fault source indicator that contains information about what type of fault source is present for an inadmissible process deviation.

The procedure need not necessarily include the execution of the machine test cycle and the condition diagnostics. It may also be provided that a machine condition indicator determined in a previous condition diagnosis is read out from a database.

For example, the fault source indicator can indicate which machine axis is affected and/or whether it is likely to be a machine fault (e.g., due to an incorrectly operating machine axis), a process fault (e.g., due to incorrect clamping of the workpiece), or an operator error.

In this context, the machine condition may be checked using a method as described in application CH 070373/2021 of Nov. 10, 2021 (patent No. CH 718264) filed by the applicant of the present application. The contents of application CH 070373/2021/patent No. CH 718264 are incorporated by reference in their entirety into the present disclosure.

The determination of a fault source indicator is also advantageous if the tolerance limit, on the basis of which the process deviation indicator was determined, was determined in a way other than by a statistical analysis of reference values. In particular, the determination of the fault source indicator is also advantageous if the tolerance limit was previously set manually. In any case, the fault source indicator provides a very strong interpretation aid that allows an operator to quickly identify a suspected fault source even without in-depth technical knowledge. The strength of this approach is that it combines information from two very different sources, one from monitoring a machining process (i.e., process diagnostics) and the other from checking the condition of the machine (i.e., condition diagnostics). This combination of information provides indications that process diagnostics alone or condition diagnostics alone could not provide in each case. It is only by relating process diagnostics and condition diagnostics to each other that new insights emerge that make it easier for the operator to identify a fault source.

In another aspect, the present invention provides a monitoring device for monitoring a machining process in a machine tool in which a workpiece is machined with a tool. The monitoring apparatus is configured to perform the method set forth above. To this end, the monitoring device may include a computer configured to execute the method. The computer may be implemented locally in a single physical location, distributed across multiple physical locations, or in the cloud. The computer may have a non-volatile memory device that stores a computer program that, when executed, causes the computer to execute said method.

The monitoring device may include one or more of the following items, which items may be implemented by the computer program executed by said computer:
a database interface configured to read the reference values from a database and, if necessary, to transfer new reference values to the database;
a limit determination device configured to perform the statistical analysis of the reference values to determine the tolerance limit;
a measured value interface configured to receive the values of the measurand, e.g. by reading the values of the measurand from a memory device of a machine controller or by directly reading out a detector to determine the measurand;
a test value determination device configured to determine a test value based on the values of the measurand;
a comparison device configured to compare the test value with the tolerance limit; and
a user interface configured to output user information, e.g. in the form of the process deviation indicator or the fault source indicator.

These items may be implemented in different physical entities. For example, the calculation of the tolerance limit may take place in the cloud, i.e. the database interface and the limit determination device can may implemented by a service in the cloud. On the other hand, the reception of measured values, the determination of the test value, the comparison with the tolerance limit and the output of the user information may be performed locally in a machine controller of the machine tool. A data interface may then be used for data exchange between the service in the cloud and the machine, via which in particular the tolerance limit may be transmitted to the machine and via which measured values and/or reference values are transmitted back to the database interface. This data interface may be implemented wirelessly or wired.

The monitoring device may further comprise a user interface configured to change at least one parameter used by the computer for automatically setting the tolerance limit, e.g. a factor by which a measure of fluctuation of the reference values is multiplied when setting the tolerance limit. The user interface may further be configured to modify an automatically set tolerance limit. The user interface may, for example, be implemented locally on a control panel of the machine tool or decentrally on a mobile device such as a laptop or tablet computer, e.g. by means of a touch screen.

The present invention further provides a machine tool comprising a monitoring device of the type described above. The machine tool may further comprise at least one of the following devices:
a tool spindle for driving a tool to rotate about a tool spindle axis;
a workpiece spindle for driving a workpiece to rotate about a workpiece spindle axis;
a movement apparatus configured to move the tool spindle and the workpiece spindle relative to each other in order to perform a machining stroke;
at least one detector for determining values of a measurand during the machining stroke.

The detector may be, in particular, a power detector for determining a measure of the power consumption of the tool spindle or workpiece spindle, or a vibration detector for determining a measure of vibrations of the machine tool.

In another aspect, the invention provides a computer program comprising instructions which, when the computer program is executed by a computer of a monitoring device, in particular the monitoring device defined above, cause that computer to execute the method set forth above. The computer program may be stored on a non-volatile storage medium.

The above explanations concerning the methods according to the invention also apply, mutatis mutandis, to the device according to the invention and the computer program according to the invention.

### BRIEF DESCRIPTION OF THE DRAWINGS

Preferred embodiments of the invention are described below with reference to the drawings, which are for explanatory purposes only and are not to be interpreted restrictively. In the drawings:

FIG. 1 shows a schematic view of a generating grinding machine;

FIG. 2 shows a schematic diagram to explain a time-dependent development of a measurand during a machining stroke;

FIG. 3 shows a diagram illustrating a statistical distribution of the maximum of a measurand for a large number of machining operations of different workpieces on the same generating grinding machine;

FIG. 4 shows a diagram illustrating a possible statistical distribution of reference values for a large number of machining operations of different workpieces on the same generating grinding machine;

FIG. 5 shows a diagram illustrating a different statistical distribution of reference values for a variety of machining operations of different workpieces on the same generating grinding machine;

FIG. 6 shows a diagram illustrating the time-dependent development of a measurand over a machining stroke and its evaluation in the time domain;

FIG. 7 shows a spectrum as obtained by a frequency analysis of the time-dependent development of a measurand;

FIG. 8 shows a diagram illustrating the comparison of test values obtained from frequency components of a measurand with frequency-dependent tolerance limits;

FIG. 9 shows a sketch of a network with several similar generating grinding machines communicating with a database via a service server;

FIG. 10A shows a flowchart for determining a tolerance limit from reference values;

FIG. 10B shows a flowchart for monitoring a machining process using the tolerance limit;

FIG. 10C shows a flowchart for determining a fault source indicator;

FIG. 10D shows a flowchart for updating the database with new reference values;

FIG. 11 shows a schematic example of a user interface for modifying the automatically calculated tolerance limits; and

FIG. 12 shows a schematic example of a user interface for outputting an information about the machining process.

### DESCRIPTION OF PREFERRED EMBODIMENTS

### Exemplary Design of a Generating Grinding Machine

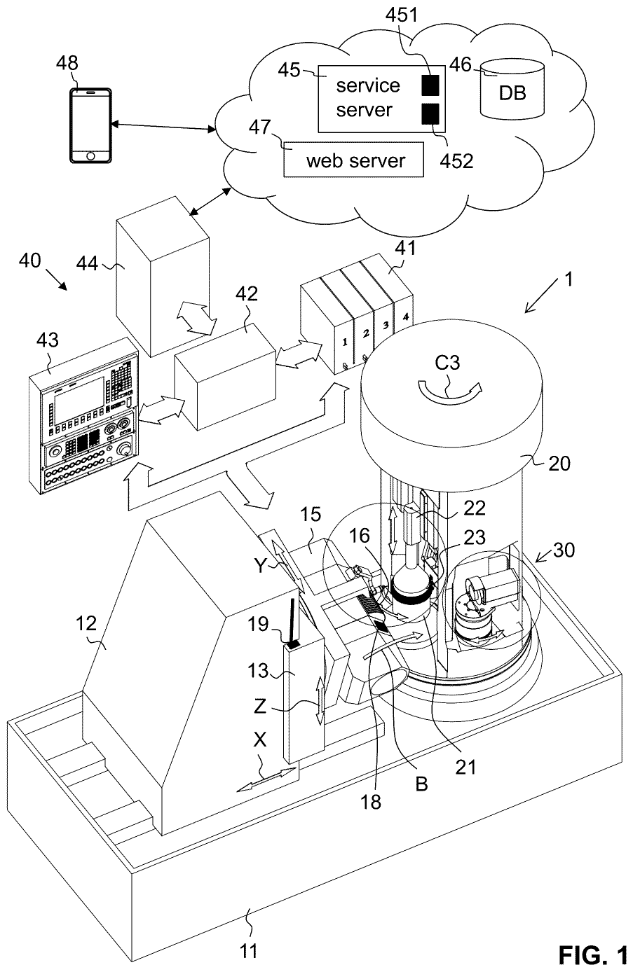

FIG. 1 shows an example of a machine tool in the form of a generating grinding machine 1, which is also referred to in the following as “machine” for short. The machine 1 has a machine bed 11 on which a tool carrier 12 is guided so as to be movable along a radial infeed direction X. The tool carrier 12 bears an axial slide 13, which is guided so as to be movable along a feed direction Z relative to the tool carrier 12. A grinding head 14 is mounted on the axial slide 13. The grinding head 14 can be pivoted about a pivot axis running parallel to the X-direction (the so-called A-axis) to adapt to the helix angle of the gear to be machined. The grinding head 14 in turn bears a shift slide on which a tool spindle 15 can be shifted along a shift direction Y relative to the grinding head 14. A grinding wheel having a worm profile (grinding worm) 16 is clamped onto the tool spindle 15. The grinding worm 16 is driven by the tool spindle 15 to rotate about a tool axis B.

The machine bed 11 also bears a pivotable workpiece carrier 20 in the form of a rotatable tower which can pivot about an axis C3 between at least three positions. Two identical workpiece spindles are mounted diametrically opposite one another on the workpiece carrier 20, of which only one workpiece spindle 21 can be seen in FIG. 1 with an associated tailstock 22. A workpiece can be clamped on each of the workpiece spindles and driven to rotate about a workpiece axis C1 or C2. The workpiece spindle 21 which can be seen in FIG. 1 is in a machining position in which a workpiece 23 clamped on it can be machined with the grinding worm 16. The other workpiece spindle, which is offset by 180° and cannot be seen in FIG. 1, is in a workpiece changing position in which a finished workpiece can be removed from this spindle and a new blank can be clamped on. A dressing (truing) device 30 is mounted offset by 90° with respect to the workpiece spindles.

Machine 1 thus comprises a plurality of movable components such as slides or spindles, which can be moved under the control of corresponding drives. These drives are often referred to in the art as “NC axes”, “machine axes” or abbreviated as “axes”. In some cases, this term also includes the components driven by the drives, such as slides or spindles.

The machine 1 also comprises a plurality of sensors. By way of example, only two sensors 18 and 19 are shown schematically in FIG. 1. Sensor 18 is a vibration sensor for detecting vibrations of the housing of the grinding spindle 15. Sensor 19 is a position sensor for detecting the position of axial slide 13 relative to tool carrier 12 along the Z-direction. In addition, however, the machine 1 comprises a plurality of further sensors. These sensors include, in particular, further position sensors for detecting a current position of one linear axis each, rotation angle sensors for detecting a rotational position of one rotational axis each, current sensors for detecting a drive current of one axis each, and further vibration sensors for detecting vibrations of one driven component each.

All driven axes of the machine 1 are digitally controlled by a machine controller 40. The machine controller 40 comprises several axis modules 41, a control computer 42 and a control panel 43. The control computer 42 receives operating instructions from the control panel 43 as well as sensor signals from various sensors of the machine 1 and calculates control instructions for the axis modules 41 therefrom. It also outputs operating parameters to the control panel 43 for display. The axis modules 41 provide control signals for one machine axis each at their outputs.

A monitoring device 44 is connected to the control computer 42.

The monitoring device 44 may be a separate hardware unit associated with the machine 1. It may be connected to the control computer 42 via an interface known per se, e.g. via the known Profinet standard, or via a network, e.g. via the Internet. It may be spatially part of the machine 1, or it may be spatially remote from the machine 1.

The monitoring device 44 receives a plurality of different measurement data from the control computer 42 during operation of the machine. Among the measurement data received from the control computer are sensor data acquired directly by the control computer 42 and data read out by the control computer 42 from the axis modules 41, for example, data describing the target positions of the various machine axes and the target current consumption in the axis modules.

The monitoring device 44 may optionally have its own analog and/or digital sensor inputs to directly receive sensor data from further sensors as measurement data. The further sensors are typically sensors that are not directly required for controlling the actual machining process, e.g. acceleration sensors to detect vibrations, or temperature sensors.

The monitoring device 44 may alternatively also be implemented as a software component of the machine controller 40, which is executed, for example, on a processor of the control computer 42, or it may be configured as a software component of the service server 45 described in more detail below. In FIG. 1, a processor 451 and a memory device 452 of the service server 45 are indicated accordingly.

The monitoring device 44 communicates directly or via the Internet and a web server 47 with the service server 45. The service server 45, in turn, communicates with a database server 46 with database DB. These servers may be located remotely from the machine 1. The servers need not be a single physical entity. In particular, the servers may be implemented as virtual units in the so-called “cloud”.

The service server 45 communicates with a mobile terminal 48 via the web server 47. The terminal 48 can, in particular, execute a web browser with which the received data and their evaluation are visualized. The terminal device does not need to meet any particular computing power requirements. For example, the terminal device may be a desktop computer, a notebook computer, a tablet computer, a cell phone, etc.

### Machining of a Workpiece Lot

For the sake of completeness, the following describes how workpieces are typically machined with machine 1.

In order to machine a workpiece that is still unmachined (a blank), the workpiece is clamped by an automatic workpiece changer on the workpiece spindle that is in the workpiece change position. The workpiece change takes place in parallel with the machining of another workpiece on the other workpiece spindle, which is in the machining position. When the new workpiece to be machined is clamped and the machining of the other workpiece is completed, the workpiece carrier 20 is pivoted 180° about the C3 axis so that the spindle with the new workpiece to be machined moves to the machining position. Before and/or during the pivoting process, a meshing operation is performed with the aid of the associated meshing probe. For this purpose, the workpiece spindle 21 is set in rotation, and the position of the tooth gaps of the workpiece 23 is measured with the aid of the meshing probe 24. The rolling angle is determined on this basis.

When the workpiece spindle bearing the workpiece 23 to be machined has reached the machining position, the workpiece 23 is brought into collision-free engagement with the grinding worm 16 by moving the tool carrier 12 along the X axis. The workpiece 23 is then machined by the grinding worm 16 in rolling engagement. This is accomplished by one or more machining strokes, for example one or more roughing strokes, followed by one or more finishing strokes. Optionally, this may be followed by one or more polishing strokes. During each machining stroke, the grinding worm 16 is continuously advanced along the Z-axis relative to the workpiece 23 (so-called axial stroke) with constant or variable radial X infeed. At the same time, the tool spindle 15 is slowly and continuously shifted along the shift axis Y in order to allow still unused regions of the grinding worm 16 to come into use during the machining (so-called shift movement). Between two machining strokes, a so-called shift jump may take place, which causes a region of the grinding worm that is not immediately adjacent to the previous region to be used in the next machining stroke. Typically, the radial X-infeed differs from machining stroke to machining stroke. As a result, the machining forces also differ between the individual machining strokes.

Parallel to the workpiece machining, the finished workpiece is removed from the other workpiece spindle and another blank is clamped on said spindle.

If, after machining a certain number of workpieces, the use of the grinding worm 16 has progressed to the point where the grinding worm is too blunt and/or the flank geometry is too inaccurate, then the grinding worm is dressed. For this purpose, the workpiece carrier 20 is pivoted by ±90° so that the dressing device 30 reaches a position in which it is opposite the grinding worm 16. The grinding worm 16 is then dressed with the dressing tool 33.

### Monitoring of a Measurand

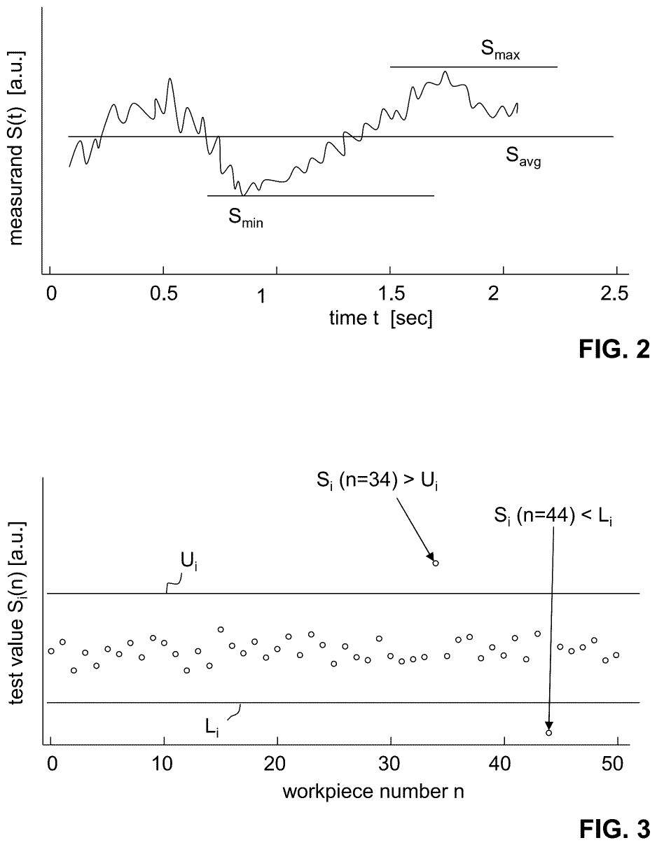

FIG. 2 schematically shows the development in time of a time-dependent measurand S(t) during a machining stroke of approx. 2 seconds in arbitrary units (a.u.). The measurand may be, for example, the current consumption of the tool spindle 15 or the signal of the vibration sensor 18. The exact development in time of the measurand over a machining stroke strongly depends on the type of measurand; in this respect, FIG. 2 is only to be understood as an example.

The measurand is digitally acquired by the monitoring device 44. For this purpose, the measurand is sampled in a known manner at a predetermined sampling frequency and digitized with the aid of an analog-to-digital converter (ADC). This results in a sequence of discrete sampled values of the measurand for successive points in time. These digitized values of the measurand are referred to as measured values in the following.

In the example of FIG. 2, these measured values are subject to fluctuations over time. Over a machining stroke, the measured values assume a maximum value Sₘₐₓ and a minimum value Sₘᵢₙ. The arithmetic mean value of the measured values over the machining stroke is S_{avg}. The values Sₘₐₓ, Sₘᵢₙ and S_{avg} are examples of time-independent test values derived from values of a time-dependent measurand. Instead or in addition, other time-independent values may also be determined as test values, e.g. a measure for the fluctuation of the measured values during the machining stroke. As will be explained in more detail below, separate test values may also be determined for different time intervals of the machining stroke, or the test values may be determined from frequency components determined by a frequency analysis of the time-dependent development of the measured values.

A test value determined in this way will usually vary from workpiece to workpiece. This is illustrated in FIG. 3. A consecutive workpiece number n is plotted along the horizontal axis, and the corresponding test value Sᵢ(n) is plotted along the horizontal axis. The test value Sᵢ(n) is compared for each workpiece with an upper tolerance limit Uᵢ and a lower tolerance Lᵢ. In the present example, the test value Sᵢ(n) for almost all workpieces is in the tolerance band between these two tolerance limits, with the exception of the values for the workpieces with the workpiece numbers n=34 and n=44. These deviations from the tolerance band indicate inadmissible process deviations in the machining of these workpieces. The corresponding workpieces may be discarded from the process accordingly, and measures may be taken to bring the process back to be within the tolerance limits.

### Automatic Setting of the Tolerance Limits

The tolerance limits Uᵢ, Lᵢ are automatically determined by a statistical analysis of a plurality of values of a reference quantity (reference values). These reference values were determined by measurements during the machining of a plurality of previous workpieces. Each reference value is based on values of the measured quantity determined during a previous machining operation on one of the previous workpieces in the same machining stroke on the same machine. In particular, the test value Sᵢ determined during the respective machining stroke when machining the respective earlier workpiece may be used as the reference value.

This is based on the consideration that, on average, over a large number of machining operations on many workpieces, the vast majority of the machining operations will not show any inadmissible process deviations, because otherwise the inadmissible process deviations would be detected sooner or later on the basis of manufacturing deviations on the workpieces thus machined. If the number of workpieces for which the reference values were determined is sufficiently large (for example, greater than 1,000 or even greater than 10,000), the distribution of the reference values across the totality of workpieces will therefore correspond in good approximation to the distribution to be expected for a perfect manufacturing process. By statistically analyzing these values, the tolerance limits can thus be automatically set on the basis of objective criteria.

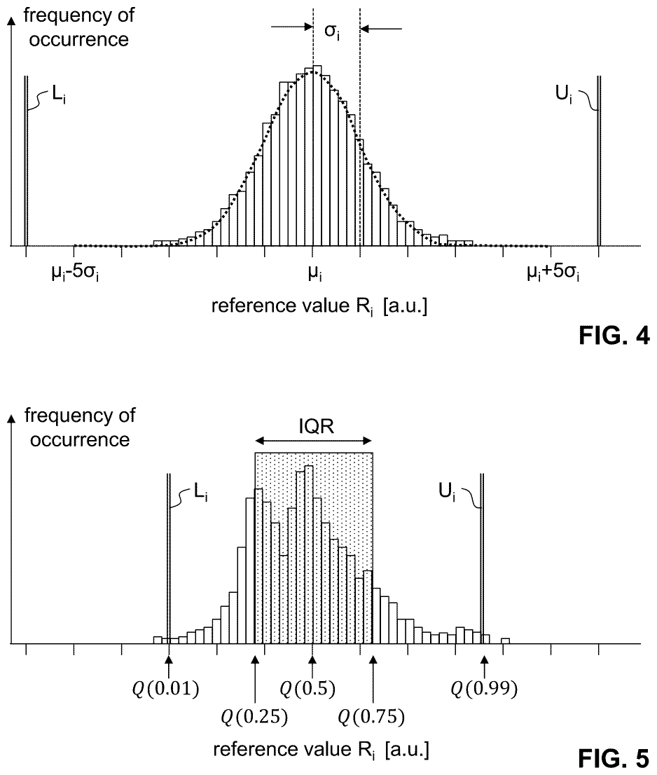

This is exemplified by FIG. 4, which shows an empirical distribution of frequency of occurrence of values of a reference quantity (reference values) Rᵢ in arbitrary units (a.u.). On the horizontal axis, the reference values are Rᵢ are plotted, on the vertical axis as a bar chart, the relative frequency of occurrence for equally large value intervals (“bins”). In the present case, this distribution of frequency of occurrence corresponds approximately to a Gaussian normal distribution, whose density function is also plotted with a dotted line in FIG. 4. For this distribution of frequency of occurrence, the arithmetic mean μᵢ of the reference values and the empirical variance σᵢ² (defined as the mean square deviation of the reference values from the arithmetic mean μᵢ) and the empirical standard deviation σᵢ (defined as the square root of the empirical variance) may be calculated.

The tolerance limits may then be set automatically based on these statistical quantities. For example, in this example, the upper tolerance limit is set as Uᵢ=μᵢ+zᵢσᵢ and the lower tolerance limit is set as Lᵢ=μᵢ−zᵢσᵢ. Here, the factor zᵢ is positive real number which can be freely chosen and which indicates by how many standard deviations the tolerance limits are spaced from the mean value μᵢ. Following the well-known 6σ-concept (which, however, is usually used for a different purpose), e.g. zᵢ=6 may be chosen. Depending on the tolerance sensitivity of the customer, another factor zᵢ may also be chosen. The factor zᵢ may thereby optionally be specified by the operator.

In the example of FIG. 4 the values of the reference quantity Rᵢ are almost normally distributed. In many cases, however, this is not the case. For example, FIG. 5 shows an empirical distribution of frequency of occurrence of reference values Rᵢ which deviates strongly from a normal distribution. Thus, the frequency distribution of FIG. 5 is bimodal and strongly asymmetric. Such a distribution is inadequately characterized by the arithmetic mean and standard deviation. In such cases, other statistical analysis methods may be more promising. Two such methods are explained below.

For example, instead of the arithmetic mean, the median Q(0.5) (i.e. the p-quantile Q(p) for p=50%) of the reference values may be calculated as a more robust form of a location parameter. Instead of the standard deviation, which can be strongly influenced by individual “outliers”, the interquartile range IQR of the reference values may for example be calculated as a more robust measure of variation, i.e. the value interval in which the middle 50% of all values of the reference values lie, or in other words the distance Q(0.75)−Q(0.25) between the p-quantiles of the frequency distribution for p=75% and p=25% (also referred to as upper and lower quartiles).

In this context, the term “p-quantile” is understood in the way that is usual in descriptive statistics for sample quantiles, namely as the smallest value below which a given fraction p of all values in the sample lie, where p is a real number between 0 and 1 and is referred to as the “undershoot” fraction.

Accordingly, the tolerance limits may be set on the basis of p-quantiles of the distribution of the reference values.

In particular, the tolerance limits may be set based on median and interquartile range. For example, the upper and lower tolerance limits may be set as follows:

$${U}_{i} = Q ( 0.5 ) + {z}_{i} ( Q ( 0.75 ) - Q ( 0.25 ) ) ,$$

$${L}_{i} = Q ( 0.5 - {z}_{i} ( Q ( 0.75 ) - Q ( 0.25 ) ) ,$$

where the factor z is again a positive real number that can be freely chosen.

An alternative determination may be made using the median and its distance from the upper and lower quantiles as follows:

$${U}_{i} = Q ( 0.5 ) + {z}_{i} ( Q ( 0.75 ) - Q ( 0.5 ) ) ,$$

$${L}_{i} = Q ( 0.5 - {z}_{i} ( Q ( 0 \text{.5} ) - Q ( 0.25 ) ) ,$$

Once again, a different determination can be made based solely on the upper and lower quartiles as follows:

$${U}_{i} = Q ( 0.75 ) + {z}_{i} ( Q ( 0.75 ) - Q ( 0.25 ) ) ,$$

$${L}_{i} = Q ( 0 \text{.25} - {z}_{i} ( Q ( 0.75 ) - Q ( 0.25 ) ) ,$$

In this case, no location parameter like the median is needed.

In an even simpler embodiment, for example, a predetermined quantile of the distribution of frequency of occurrence of the reference values can be used directly as the tolerance limit. For example, the 99% quantile Q(0.99) (often referred to as the “last percentile”) may be set as the upper tolerance limit and the 1% quantile Q(0.01) (the “first percentile”) may be set as the lower tolerance limit. In this case, the “undershoot” fraction p by which the corresponding quantile is determined may be specified by the operator.

Several statistical methods may also be combined when determining a tolerance limit. For example, the upper tolerance limit may be defined as a weighted average of the upper tolerance limits calculated using two different methods.

Alternatively, two or more upper and/or lower tolerance limits may also be defined for a test value, the tolerance limits having been determined by different statistical methods. For example, the test value may be compared, on the one hand, with a first upper tolerance limit, which has been calculated as Uᵢ=μᵢ+zᵢσᵢ, and on the other hand with a second upper tolerance limit, which has been calculated as Uᵢ=Q(0.75)+zᵢ(Q(0.75)−Q(0.25)). If only one of these two upper tolerance limits is exceeded, an inadmissible process deviation may be concluded.

Implementation with Database

The reference values may be determined in advance and stored in the database 46. The automatic setting of the tolerance limits is then performed by the monitoring device 44 by accessing the database 46, reading out the reference values from this database and analyzing them statistically.

After a workpiece has been successfully machined, the monitoring device 44 may calculate a new value of the reference quantity from the measured values for this workpiece and store it in the database 46. In this way, new reference values are continuously added to the database, which are then available for setting the tolerance limits of subsequent workpieces. This makes the monitoring device self-learning to a certain extent.

### Time-Varying Tolerance Limits

In the example of FIG. 3, a time-independent test value was determined for a time-dependent measurand, and this test value was compared with an upper and lower tolerance limit. Instead or in addition, it is also possible to compare test values that have been determined specifically for certain time intervals during a machining stroke with tolerance limits. These tolerance limits may themselves be time-dependent, i.e. different tolerance limits may be intended for different time intervals.

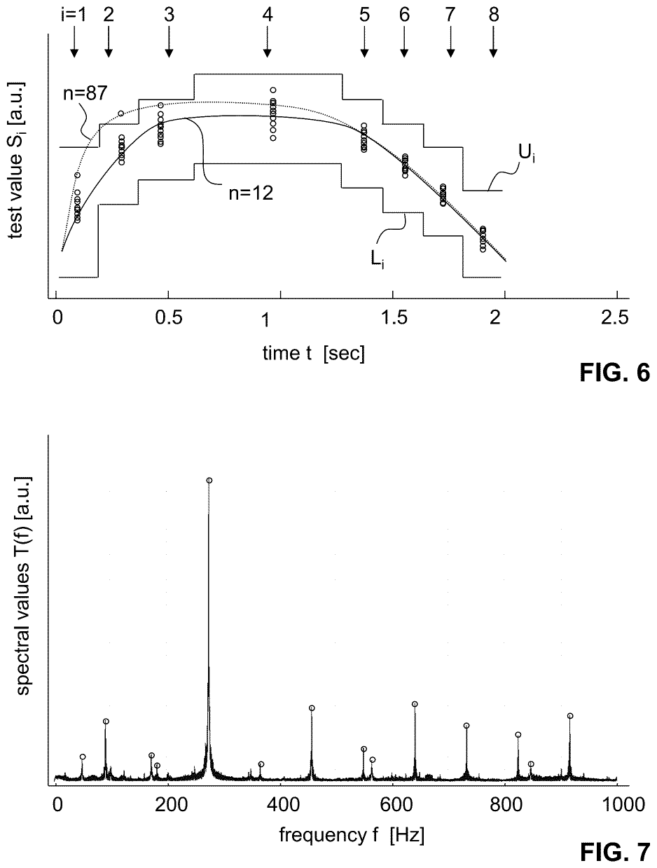

This is illustrated in FIG. 6. The latter shows with a solid line a development of a time-dependent measurand S(t) for a specific workpiece (in this example the workpiece with the workpiece number n=12). In this example, the measurand first increases during a machining stroke, then reaches a plateau, and finally drops again. The power consumption of the tool spindle, for example, may show such a curve if the tool first gradually engages with the workpiece, machines the workpiece in full engagement and then gradually disengages again. Typically, a noise component is superimposed on this curve, but this is not shown in FIG. 6 for reasons of clarity.

Also illustrated in FIG. 6 are upper and lower tolerance limits Uᵢ and Lᵢ which have been set separately for a plurality of time intervals i. In the present example, there are a total of 8 such time intervals with assigned upper and lower tolerance limits. During the machining stroke, the measurand is S(t) is digitally recorded, and test values Sᵢ derived from the values of the measurand are continuously compared with these tolerance limits in order to be able to detect inadmissible process deviations. In the example of FIG. 6, the test value Sᵢ is simply the value of the measurand S(t) in the middle of the respective time interval.

The circles in FIG. 6 illustrate the fluctuations of the test values Sᵢ in the intervals i from workpiece to workpiece. In the present example, these values lie mostly between the assigned tolerance limits Uᵢ and Lᵢ. Only for one of the workpieces (here the workpiece with the workpiece number n=87) the value of the measurand S(t) during the time interval i=2 exceeds the upper tolerance limit Uᵢ. The complete development of the measurand S(t) drawn with a dashed line for this workpiece shows that the measurand has increased unexpectedly quickly. Exceeding the upper tolerance limit indicates an inadmissible process deviation. Accordingly, the workpiece in question may be taken out and examined more closely or discarded, and if necessary, the machine condition may be examined, or the process may be adjusted.

The tolerance limits Uᵢ and Lᵢ may again be determined automatically by a statistical analysis. For this purpose, values of the measured S(t) which were determined in previous machining operations are taken into consideration. For each time interval i a characteristic value of the measurand S(t) is determined as the reference value, for example the average of the digitized values of the measurand S(t) during this time interval or the value of the measurand S(t) in the middle of the time interval. The distribution of these reference values is then statistically analyzed in a manner similar to that described above in connection with FIGS. 3-5. In particular, statistical parameters for these reference values may again be determined, in particular a location parameter and a measure of dispersion, and the tolerance limits may be calculated therefrom. In this way, for each of the time intervals i a separate upper tolerance limit Uᵢ and a separate lower tolerance limit Lᵢ are determined.

In a further development, it is also conceivable that a test value is determined for each time interval, which characterizes the behavior of the measurand S(t) in this time interval in another way than only by a current value in the middle of the time interval. For example, a mean value of the measured values may be determined for each time interval as a test value, or a regression analysis of the measured values may be performed to determine a test value that characterizes the change over time of the measured values in the respective interval. For example, a slope of the measured values in the relevant time interval may be determined as a test value. Tolerance limits may then be automatically determined for this test value by statistically analyzing, as reference values, the correspondingly calculated test values during the machining of previous workpieces.

### Frequency-Dependent Tolerance Limits

For a time-dependent measurand, the comparison with tolerance limits may also be carried out in the frequency domain instead of the time domain. For this purpose, a frequency analysis of the digitized time-dependent values of the measurand is first performed to determine multitude of frequency components of the measurand. This may be done by applying a suitable transformation to the time-dependent values of the measurand, in particular a discrete Fourier transform (DFT), which may be implemented concretely as a fast Fourier transform (FFT). However, other methods may also be used to perform a frequency analysis, for example a wavelet analysis.

The result of such a frequency analysis is schematically illustrated in FIG. 7. FIG. 7 shows a spectrum of a measurand in the form of a multitude of frequency components (spectral values) T(f) as a function of frequency f. The spectrum was obtained by filtering and DFT of a time-dependent measurand. In the spectrum several peaks are recognizable, which are marked by circles. The frequency components in the region of these peaks are of particular interest for the following analysis.

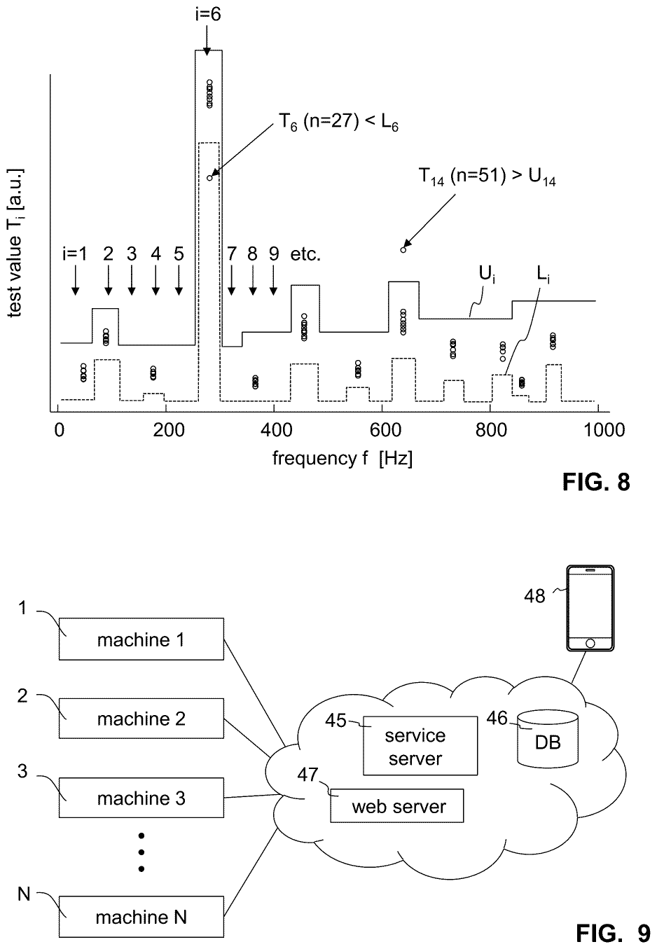

Various frequency intervals are now specified for this spectrum. For each of the frequency intervals, at least one test value is compared with one or more frequency-dependent tolerance limits. This is illustrated in FIG. 8. In this figure, an upper tolerance limit Uᵢ(solid line) and a lower tolerance limit Lᵢ (dashed line) are shown for a multitude of frequency intervals i. In addition, for each frequency interval, several test values, which were determined from the frequency components of the measurand in the respective frequency interval on the basis of measurements on different workpieces, are shown as circles. The respective test value may be, for example, the integral or the maximum of the frequency components in the respective frequency interval.

The frequency intervals may, for example, be chosen to be so narrow that there is exactly one peak in each frequency interval, and the intensity of the peak in question may serve as the test value. The assigned tolerance limits then define the permissible range in which the intensity may move. The intensity of the peak may be determined, for example, by integrating the spectrum in the relevant frequency interval or as the maximum value of the frequency components in the relevant frequency interval. However, the frequency intervals may also be chosen to be wider, so that several peaks are located in one frequency interval. Accordingly, the test value may also be defined in a more complex way. The frequency intervals do not necessarily have to be directly adjacent to each other. For example, it is possible to compare only the intensities of selected peaks with tolerance limits, e.g. peaks at certain multiples of the workpiece or tool rotational speed. The intensities of peaks at certain multiples of these frequencies allow direct conclusions to be drawn about certain types of process deviations, as will be discussed in more detail below.

In the example of FIG. 8, the integral of the frequency components in the relevant frequency interval was chosen as the test value for each frequency interval. In this example, most of the test values are in the range between the assigned tolerance limits. Only the test value for the workpiece with the workpiece number n=27 for the frequency interval i=6 falls below the lower tolerance limit L₆, and the test value for the workpiece with the workpiece number n=51 for the frequency interval i=14 exceeds the upper tolerance limit U₁₄. Again, this indicates certain process deviations. Under certain circumstances, the frequency interval in which the deviation occurs even allows direct conclusions to be drawn about the type of process deviation.

Any upper and/or lower tolerance limit Uᵢ resp. Lᵢ may be determined by a statistical analysis of reference values determined for previous machining operations. The reference value may be, for example, the respective test value for the respective frequency interval that was determined for a previous workpiece.

The comparison with the tolerance limits may be carried out repetitively (cyclically) for each machining operation by continuously determining new test values and comparing them with the tolerance limits. For example, a frequency analysis may be performed continuously during machining, and the resulting frequency components or the test values obtained therefrom may be continuously compared with the tolerance limits.

### Normalization Operation

One difficulty of process monitoring, particularly in gear cutting, is the fact that the monitored measurands depend in a highly complex manner on a large number of geometric properties of the tool (in the case of a grinding worm, for example, diameter, module, number of threads, lead angle, etc.), geometric properties of the workpiece (e.g. module, number of teeth, helix angle, etc.) and setting parameters on the machine (e.g. radial infeed, axial feed, rotational speeds of the tool and workpiece spindles, etc.). Due to these diverse, complex dependencies, it is on the one hand extremely challenging to draw direct conclusions from the monitored measurands about concrete process deviations and the machining errors caused by them. On the other hand, it is extremely difficult to compare the measurands from different machining processes with each other. An additional challenge arises when using dressable tools. Dressing changes the diameter of the tool over the course of machining a series of workpieces, and thus the machining conditions also change. As a result, the monitored measurands from different dressing cycles are not directly comparable even within the same series of workpieces, even if all other framework conditions remain the same.

In order to compensate for differences in the machining conditions of different workpieces, a normalization operation may be applied to the measured values or to the test values determined therefrom. The normalization operation takes into account the influence of one or more process parameters on the measured values or test values, in particular the influence of geometric parameters of the fine machining tool (in particular its dimensions, specifically in particular its outside diameter), geometric parameters of the workpiece and/or setting parameters of the fine machining machine (in particular radial infeed, axial feed and rotational speeds of the tool and workpiece spindles). The resulting normalized test values are thus independent of, or at least much less dependent on, the above-mentioned process parameters than without normalization. Thanks to the normalization operation, the normalized values are comparable between different machining operations even if these process parameters differ. In particular, this may eliminate the need to define tolerance limits that depend on the process parameters.

The normalization operation is preferably based on a model describing an expected dependence of the measurand on the mentioned parameters. If the measurand is a performance indicator, the model preferably describes the dependence of the process power (i.e. the mechanical or electrical power required for the machining process performed) on said parameters. In particular, the process performance model may be based on a force model describing an expected dependence of the cutting force effective at the point of contact between the finishing tool and the workpiece on geometric parameters of the finishing tool, geometric parameters of the workpiece, and setting parameters of the finishing machine. The process performance model may also take into account the length of a lever arm that is effective between the tool axis and a contact point between the fine machining tool and the workpiece. In particular, the lever arm length may be approximated by the outside diameter of the fine machining tool. In addition, the process performance model may take into account the rotational speed of the tool spindle.

The normalization operation may, for example, comprise a multiplication of the recorded measured values or quantity derived therefrom by a normalization factor. However, more complex normalization operations are also conceivable. If the measured values comprise the values of a performance indicator, the normalization factor may in particular be an inverse performance quantity calculated on the basis of the process performance model for the specific processing situation at hand, or a quantity derived therefrom.

The normalization operation is preferably applied directly to the recorded values of the measurand, if necessary after filtering. The normalization operation is advantageously performed in real time, i.e. still during the machining process, in particular still during the machining of the respective workpiece, i.e. still while the tool is in a machining engagement with the workpiece. As a result, normalized values are available immediately during the machining process and may be used in real time to monitor the machining process.

The normalization operation may be recalculated each time at least one of the process parameters changes. The recalculation of the normalization operation then preferably includes applying the mentioned model with the changed process parameters.

With respect to further considerations of the normalization operation, reference is made to publication document WO2021048027A1, the content of which is incorporated by reference in their entirety into the present disclosure.

### Carrying Out Condition Diagnostics in the Presence of Inadmissible Process Deviations

If a process deviation is detected, it may be useful to investigate the cause of the process deviation. For this purpose, automatic diagnostics of the machine condition may be carried out, or existing data determined during such diagnostics may be used. For the diagnostics of the machine condition, a test cycle is carried out in which at least one part of the machine axes is specifically actuated, and condition data associated with this actuation is determined by measurements. This condition data may then be used to perform condition diagnostics in which the condition data is compared to at least one reference condition variable to determine at least one machine condition indicator. A fault source indicator may then be determined from the process deviation indicator and the machine condition indicator, indicating, for example, whether a machine error, a pre-processing error or an operating error is present.

For example, in gear machining, a detected process deviation may be that the intensity of the frequency component of the drive power of the tool spindle exceeds an upper tolerance limit at the rotational speed of the workpiece spindle. This process deviation may have various causes. For example, one cause may be an inadmissible total pitch error of the workpiece blank due to faulty pre-machining. However, the process deviation may also be the result of an imbalance due to faulty workpiece clamping or the result of a faulty workpiece spindle.

In order to investigate the cause of this process deviation, diagnostics of the workpiece spindle with the workpiece clamped on it, but without machining intervention with the tool, may then be carried out. If this does not reveal any abnormalities, it can be concluded that the process deviation was the result of a pre-machining error of the workpiece. Otherwise, condition diagnostics of the workpiece spindle without the workpiece clamped on it may follow. If this does not reveal any abnormalities, it can be concluded that the process deviation was the result of a workpiece clamping error. Otherwise, it can be concluded that the process deviation was caused by a defective workpiece spindle.

In this way, the operator receives direct information, even without having in-depth specialist knowledge, which allows him to make a differentiated assessment of the machining process and the condition of the machine.

This procedure is also advantageous if the tolerance limits were set in a different way than described above, for example, if the tolerance limits were set purely manually.

### Realization in the Cloud

The calculation and monitoring of the tolerance limits may be performed locally in a monitoring device that is directly associated with the machine tool. However, it is also conceivable to execute at least part of these procedures in the cloud. An example is illustrated in FIG. 9.

Via a web server 47, the machine 1 to be monitored and a plurality of other machines 2, 3, . . . , N are connected to a service server 45 and to a database 46. The service server 45 and the database 46 are located in the cloud.

Each of these machines has a monitoring device that continuously transmits certain data to the database 46 during operation of the respective machine. This data includes, in particular, a unique identifier of the machine, a time stamp, and a plurality of test values as described above. The data may optionally also comprise further data, for example data on measurements made on the workpieces subsequent to production, e.g. indicators of the workpiece quality achieved.

This data is stored in the database DB. As a result, over time the database contains a very large amount of process data obtained for several machines in many different machining operations. This data may be accessed for future machining processes. For example, the stored test values may serve as reference values when determining tolerance limits for future machining processes.

The results of the monitoring may be retrieved and visualized in a decentralized manner from any location. The web server 47, which communicates with the decentralized mobile terminal 48, e.g. a tablet computer, is used for this purpose.

### Flowcharts

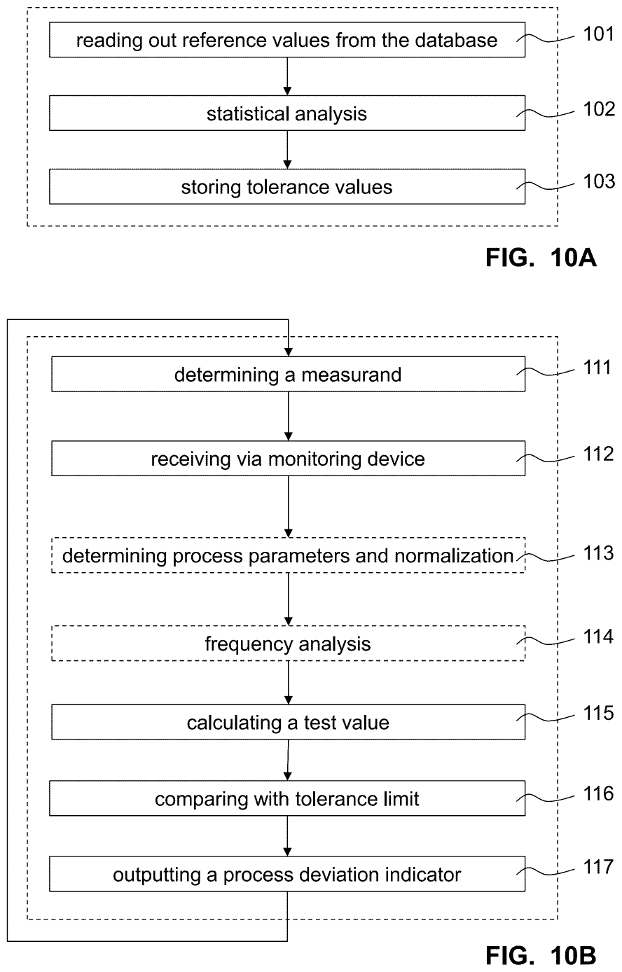

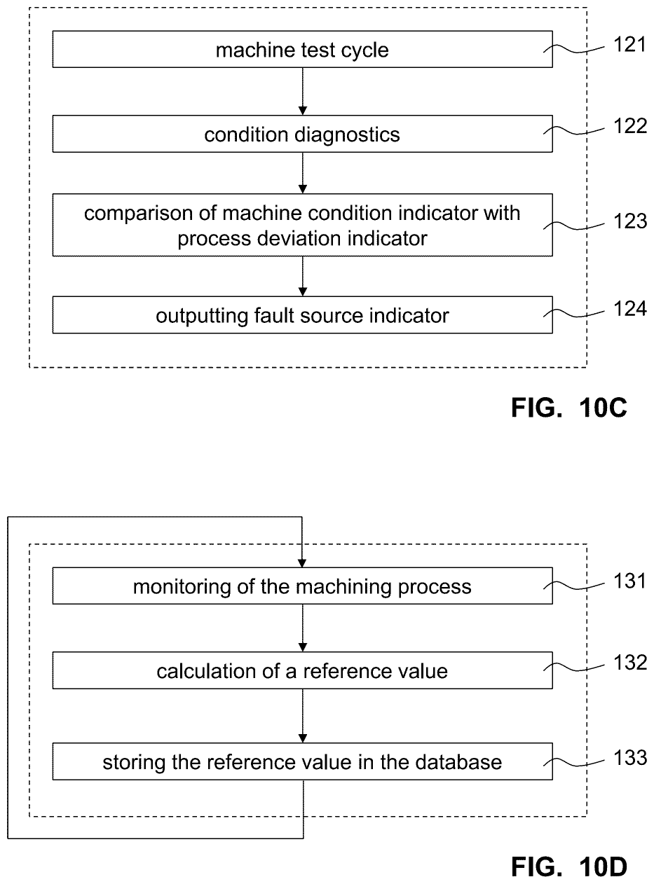

FIGS. 10A to 10D show flowcharts that summarize the method described above in a concise graphical manner.

Here, FIG. 10A illustrates steps for determining a tolerance limit. In step 101, a monitoring device reads reference values from a database. In step 102, the monitoring device performs a statistical analysis of the reference values to determine a tolerance limit. In step 103, the monitoring device stores the tolerance limit in a memory device of the monitoring device so that this tolerance limit may be accessed later.

FIG. 10B illustrates steps for determining a deviation indicator. In step 111, values of a measurand are determined by measurements. In step 112, the monitoring device receives these measured values. In optional step 113, the monitoring device determines associated process parameters, e.g., by reading them from a machine controller, and applies a normalization operation that takes these process parameters into account. In optional step 114, the monitoring device performs a frequency analysis. In step 115, the monitoring device calculates a test value from the (optionally normalized) measured values or their frequency components. In step 116, the monitoring device compares the test value with the previously determined tolerance limit and thereby determines a deviation indicator. In step 117, the monitoring device outputs the deviation indicator to the machine controller or to a user interface. Steps 111-117 are repeated cyclically during the machining of a workpiece.

FIG. 10C illustrates steps for determining a fault source indicator. In step 121, the monitoring device performs a test cycle. In step 122, the monitoring device performs condition diagnostics based on the measurement results of the test cycle to determine a machine condition indicator. Alternatively, the monitoring device reads a machine condition indicator, which has already been determined in a previous condition diagnostics procedure, from a database. In step 123, the monitoring device compares the machine condition indicator with the previously determined process deviation indicator. In step 124, the monitoring device outputs the fault source indicator.

FIG. 10D illustrates how the measured values determined during the monitoring of a current machining process may be used to determine and store new reference values. In step 131, a machining process is monitored. This is done in the manner illustrated in FIG. 10B. In the course of this machining process, values of a measurand (measured values) are continuously determined. A new reference value is calculated from the measured values in step 132. In step 133, this reference value is stored in the database from which the previous reference values had previously been read out in FIG. 10A. In this way, new reference values are added to the database during each machining process.

### User Interface

The monitoring device 44 may provide a user interface that allows a user to specify one or more parameters that the monitoring device requires to perform the automatic setting of tolerance limits, such as the parameter zᵢ mentioned above or a particular “undershoot” value p for which the corresponding p-quantile of the distribution of the reference values is to serve as the tolerance limit. The user interface may also allow the user to manually change the automatically calculated tolerance limits.

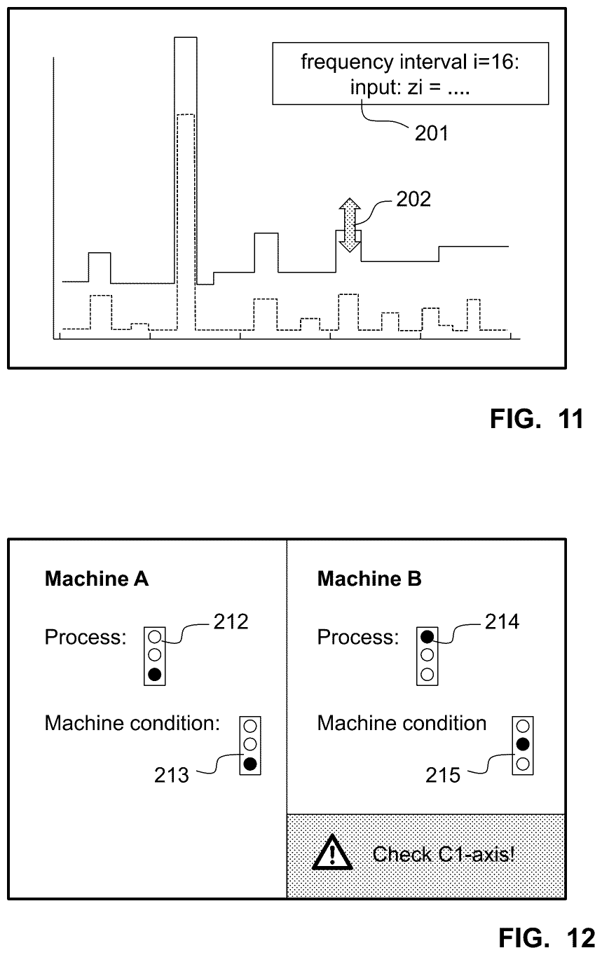

In FIG. 11, a highly simplified user interface is illustrated in a highly schematic manner. Here, for each frequency interval, the operator may enter the factor zᵢ in a box 201. The resulting tolerance limits are displayed graphically to the operator. By dragging an arrow 202, the operator may manually change each tolerance limit.

The monitoring device 44 may further provide a user interface that allows output of a user information based on the comparison of the test values with the tolerance limits. In FIG. 12, such a user interface is illustrated in a highly simplified form and in a highly schematic manner. The user interface illustrated here shows for two machines “A” and “B” the quality of the current machining process and the state of the machine tool. This display is implemented here in the manner of a signal light system: a machining process in which all test values are at a minimum distance from the tolerance limits is represented by a signal light indicating green, a process with inadmissible process deviations by a light indicating red, and a process in which test values are very close to the tolerance limits by a signal light indicating yellow. The machine status is also displayed in a similar manner.

In the example of FIG. 12, the signal light 212 for the machining process on machine A is green, and the signal light for the machine status of machine A is also green. The user thus sees at first glance that everything is in order on the machine A.

On the other hand, signal light 214 for the machining process on the machine B is red, i.e., an inadmissible process deviation was detected in this machining process. The signal light 215 for the machine status of machine B is set to yellow, i.e. at least one axis of the machine B was found to be critical during machine diagnostics. In the present example, it is assumed that this is the C1 axis (i.e. one of the two workpiece spindles).

For example, the process deviation indicator may show that frequency components of the drive power of the tool spindle or a vibration signal of the vibration sensor 18 are outside the tolerance limits at the rotational speed of the workpiece spindle and multiples thereof, and the condition diagnostics may have revealed that increased vibrations occur when the workpiece spindle is actuated even if no workpiece is clamped on the workpiece spindle. As explained above, this collectively indicates a faulty C1 axis. The comparison of the process deviation indicator and the machine condition indicator thus shows here that the C1 axis is most likely responsible for the detected process deviation, i.e. through the comparison, a fault source indicator was determined that points to the C1 axis as the fault source. Accordingly, the user interface issues a warning “Attention: Check C1 axis!” to the user.

The user then has the possibility to follow up this indication in detail. For example, the user interface may provide a display in which a comparison of test values with the associated tolerance limits is shown graphically in a similar way to FIG. 3, 6 or 8, so that it is easy to see which frequency components exceed the associated tolerance limits and to what extent.

The user interfaces may be implemented, for example, in the control panel 43 or in the mobile terminal 48.

Of course, countless other implementations of such user interfaces are also possible.

### Variations

The invention is not limited to the embodiments described above, and a wide variety of variations are possible without departing from the scope of the invention as defined in the claims.

In particular, statistical methods other than those described above may be used to determine the tolerance limits. This also includes machine learning algorithms. For example, the reference values together with an associated quality indicator in each case may serve as the training data set for such a machine learning algorithm, with the quality indicator specifying a measure of the quality of the machining process with which the respective reference value was obtained. The quality indicator may, for example, be determined subsequently by (contact or non-contact) measurements on the workpiece for whose machining the reference values were obtained. Alternatively, the quality indicator may be determined by measurements in an EOL test rig. After a desired machining quality has been specified, a machine learning algorithm trained in this way may, for example, automatically determine tolerance limits whose compliance is expected to result in the desired machining quality.

While the invention has been explained with reference to generating gear grinding, the invention is also applicable to other types of gear machining, such as gear hobbing, gear skiving, gear honing, profile grinding, and so forth. Also, the invention is applicable to methods for machining types of workpieces other than gears.

1. A method for monitoring a machining process in a machine tool, in which a workpiece is machined with a tool in one or more machining strokes, comprising:
receiving values of a measurand, wherein the values of the measurand have been determined by measurements on the machine tool during the machining stroke; and
comparing at least one test value, with a tolerance limit, the at least one test value being based on the values of the measurand,
wherein the tolerance limit is determined by performing a statistical analysis of a plurality of reference values which have been determined by measurements made during the machining of a plurality of previous workpieces, wherein each reference value is based on one or more values of the measurand determined during machining of one of the previous workpieces, and
wherein, during the statistical analysis of the reference values, a measure of dispersion for the reference values is determined and the tolerance limit is set based on the measure of dispersion.

2. The method of claim 1, wherein the reference values are stored in a database and the method comprises retrieving the reference values from the database.

3. The method of claim 2, wherein the method comprises:
calculating a new reference value based on one or more of the values of the measurand, and
updating the database by storing the new reference value in the database.

4. The method of claim 1, wherein each reference value corresponds to a test value that has been determined for a previous workpiece.

5. The method of claim 1,
wherein time-dependent values of the measurand are received for a plurality of points in time during a machining stroke,
wherein the test value is time-independent and is calculated from said time-dependent values of the measurand,
wherein each reference value is time-independent and based on time-dependent values of the measurand during a machining stroke while machining one of the previous workpieces,
wherein, by the statistical analysis of the time-independent reference values, at least one time-independent tolerance limit is determined, and
wherein the time-independent test value is compared with the at least one time-independent tolerance limit.

6. The method of claim 1,
wherein time-dependent values of the measurand are received for a plurality of points in time during the machining stroke,
wherein a plurality of time intervals of the machining stroke is specified,
wherein for each of the time intervals at least one associated test value is determined which is based on the values of the measurand in the respective time interval,
wherein for each of the time intervals at least one tolerance limit is determined,
wherein each reference value is specific to one of the time intervals and is based on time-dependent values of the measurand during the machining of one of the previous workpieces in the respective time interval, and
wherein for each of the time intervals the at least one test value is compared with the at least one tolerance limit for the respective time interval.

7. The method of claim 1,
wherein time-dependent values of the measurand are received for a plurality of points in time during the machining stroke,
wherein a frequency analysis of the time-dependent values of the measurand is performed to determine a plurality of frequency components of the measurand,
wherein a plurality of frequency intervals is specified,
wherein for each of the frequency intervals at least one associated test value is determined, which is based on the frequency components in the respective frequency interval,
wherein for each of the frequency intervals at least one tolerance limit is determined,
wherein each reference value is specific to one of the frequency intervals and is based on frequency components in the respective frequency interval which have been determined by a frequency analysis of time-dependent values of the measurand during machining of one of the previous workpieces, and
wherein for each of the frequency intervals the at least one test value is compared with the at least one tolerance limit for the respective frequency interval.

8. The method of claim 1, wherein the workpiece is machined in at least two machining strokes, and wherein the tolerance limit is specific to the respective machining stroke.

9. The method of claim 1,
wherein the measure of dispersion is a standard deviation or a size of a value interval in which a predetermined proportion of all reference values lies.

10. The method of claim 1,
wherein the measure of dispersion is a value interval in which a specified proportion of all reference values lies, and
wherein a limit of said value interval forms the tolerance limit.

11. The method of claim 1,
wherein the tolerance limit is determined by combining at least two statistical analysis methods, or
wherein the at least one value of the measurand or the test value derived therefrom is compared with at least two tolerance limits that have been determined by different statistical analysis methods.

12. The method of claim 1, wherein the measurand is at least one of the following quantities or is derived from at least one of the following quantities:
a power indicator that is a measure of an instantaneous power consumption of a tool spindle or workpiece spindle of the machine tool; or
a vibration indicator that has been determined with at least one vibration sensor and that represents vibrations of the machine tool.

13.-14. (canceled)

15. The method of claim 1, the method comprising:
outputting information based on the comparison of the at least one test value with the tolerance limit; and/or
influencing the machining process depending on a result of the comparison of the test value with the tolerance limit.

16. The method of claim 1, the method further comprising:
determining a process deviation indicator based on the comparison of the at least one test value with the tolerance limit; and
outputting the process deviation indicator or an information that is based on the process deviation indicator.

17. The method of claim 16, wherein the method further comprises:
reading a machine condition indicator that has been determined by condition diagnostics of the machine tool, wherein the condition diagnostics involved comparing condition data with at least one reference condition variable to determine at least one machine condition indicator, and wherein the condition data was determined by measurements in a machine test cycle in which at least a portion of the machine axes was selectively actuated and condition data associated with that actuation was determined by measurements; and
determining a fault source indicator from the process deviation indicator and the machine condition indicator, wherein the fault source indicator contains an information about what type of failure source is present for an inadmissible process deviation.

18. A method for monitoring a machining process in a machine tool, in which a workpiece is machined with a tool in one or more machining strokes, comprising:
receiving values of a measurand, wherein the values of the measurand have been determined by measurements on the machine tool during the machining stroke; and
comparing at least one test value that is based on the values of the measurand with a tolerance limit,
determining a process deviation indicator based on the comparison of the at least one test value with the tolerance limit;
reading a machine condition indicator determined by condition diagnostics of the machine tool, wherein the condition diagnostics involved comparing condition data with at least one reference condition variable to determine at least one machine condition indicator, and wherein the condition data was determined by measurements in a machine test cycle in which at least a portion of the machine axes was selectively actuated and condition data associated with that actuation was determined by measurements; and
determining a fault source indicator from the process deviation indicator and the machine condition indicator, wherein the fault source indicator contains an information about what type of failure source is present for an inadmissible process deviation.

19. The method of claim 18, comprising:
outputting an information based on the fault source indicator.

20. A monitoring device for monitoring a machining process in a machine tool in which a workpiece is machined with a tool, the monitoring device comprising a processor and a non-volatile memory device storing a computer program that, when executed by the processor, causes the monitoring device to perform the method of claim 1.

21. The monitoring device of claim 20, comprising a user interface configured to allow a user to change at least one parameter which is used by the computer for automatically setting the tolerance limit, and/or to manually change an automatically set tolerance limit.

22. The monitoring device of claim 20, comprising a user interface configured to output an information based on the comparison of the at least one test value with the tolerance limit.

23. (canceled)
